(19) United States
(12) Patent Application Publication
(10) Pub. No.: US 2007/0248036 A1
(43) Pub. Date: Oct. 25, 2007

(54) Method and Device for Restricted Execution of Applications on a Mobile Terminal

(75) Inventor: Mikko Nevalainen, Herne (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/599,947

(22) PCT Filed: Apr. 15, 2004
(86) PCT No.: PCT/IB04/01138

§ 371 Date: Feb. 26, 2007

(51) Int. Cl. H04Q 7/00

(52) U.S. Cl. 370/328

(57) ABSTRACT

During standard operation (40) of a mobile device, the system detects user input to start a game application (42). The system ten initiates a message transmission indicating the execution of the game (44). If the mobile device is within predetermined geographical limits,the system authorizes execution of the game. (48)

The present invention relates to applications and devices using applications. More specifically, the present invention relates to mobile gaming and mobile gaming devices. It also relates to a new way of distributing and using applications and game applications on mobile devices. The present invention can also be applied to mobile game-applications and invoicing. Specifically the invention is directed to the restricted execution of game applications.

Currently e.g. game software is purchased by the user, who installs it into the terminal, and plays the game. One disadvantage is that the user has to pay a large amount of money for the game, without knowing if he really likes the game and will play/use it often. This might keep some customers from purchasing a game. Traditionally games are purchased from a store. Users are paying for owning the game, while having little or no possibilities of actually testing it.

With an expensive game title this may prove especially undesirable for a user who is not satisfied with the purchased game. Additionally, the copy protection of the game needs to be good in order to prevent copying, which is more interesting at high price games, and which also contributes to the high price of the game. Setting up the conventional distribution channels for the game requires time and money.

Demo versions of games have also been used in the past. The Internet has been a distribution channel for some application but the concept of owning software is still in use.

In the state of the art mainly two different payment procedures for gaming applications are used:
A user can download e.g. Java-Games from a game provider to his cellular phone. The download is usually charged as an item on the next cellular telephone bill. Due to the relatively low bandwidth provided by the mobile telephone network for a data download, this procedure is only applicable for relatively simple applications not requiring the transfer of huge amounts of data.
The games software can also be purchased stored on a storage device such as Multimedia (MMC-) cards, wherein the costs for the game and the storage medium is between 20 and 40 [symbol] and $, respectively.

In both cases the user has to pay the full price in advance and can unlimitedly use the application. One disadvantage for the user resides in that at the time the user pays for the software the user is not fully aware if the game is really perceived as exciting as expected, i.e. is worth its price. The user is also not fully aware if he is going to play the game as often as he expects.

Another drawback of the state of the art is the necessity to protect the software against unauthorized copying. Additionally, there is actually no ultimately safe copy protection on the market, and when a method to circumvent the copy protection is found the software may be copied and used in any number.

From the document EP 1 229 476 it is known that software may be put at the customers disposal for a certain test period without charging. After a predetermined time or a number of application starts, the software automatically sets up an online connection to the manufacturer of the software, and the user has to buy the software for further unlimited access.

All the above approaches for distributing applications and software especially software and game software have in common that they can not provide any alternative to the necessity to own it.

According to a first aspect of the present invention, there is provided a method for executing an application on a mobile terminal device. The method comprises the steps of detecting a user input to start the execution of an application on said mobile terminal device, initiating a transmission of a message to a surveillance center, starting a restricted execution of said application, within predetermined limits, after said transmission of said message has been initiated. The step of starting a restricted execution may include the steps of starting an execution first and implementing a restriction thereof later.

The expression ‘restricted’ may be interpreted as a restriction with regard to a restriction of the available application execution time, and not primarily of restricting the functionality elements of the application.

By detecting a user input to start the execution of an application on said mobile terminal device the game or the application as such can be started. As the present invention is strongly tied to the execution of an application, the application has to be started anyway.

Upon starting said application or after e.g. a certain period of time has passed or after a number of input actions, after starting and executing said application the device initiates a transmission of a message, i.e. tries to send or transmit a message to a surveillance center, notifying that the application has been started.

Following the initiation of said message a restricted execution of said application is started, within predetermined limits, if said message has been initiated successfully. At this point of time it is preferably not yet defined what happens if the message could not be sent. The enabling of a restricted execution of an application is for example possible.

This restricted execution after the dispatching is an important aspect of the present invention. The device notifies an instance or a device in a wireless network that a certain application has been started or is actually in use. This basic method can be used for a strictly statistical approach: i.e. to survey and collect data on how often e.g. a game application is actually played (even without charging). The user may pay for the message in following applications eventually using also a value-added service for transferring the message.

As the use of the application is subject to certain conditions, it is possible to distribute the application freely. The statistical data obtained by the method of the present invention may be used to collect and plan an application release more precisely. As the use of the application is subject to certain conditions, it is possible to distribute the price-reduced applications that are subject to a reduced notification service. It is to be noted that the processing of multimedia content such as playing music/video files with a replay application should fall under the wording of ‘executing an application’.

In one example embodiment of the present invention said method further comprises actually transmitting said message to said surveillance center, and starting said restricted execution of said application, within predetermined limits, after said message has been sent. This embodiment represents the case the present invention is intended for. That is a notification message is actually sent to a surveillance center and notifies the surveillance center of the execution of said application on said terminal device.

Following to the dispatching of said message a restricted or conditional execution of said application is started, within predetermined limits, if said message has been sent successfully. At this point of time it is preferably not yet defined what happens if the message could not be sent.

This restricted or conditional execution after the dispatching is an important aspect of the present invention. The device notifies an instance in a network that a certain application has been started or is actually in use. This basic method can be used for a strictly statistical approach: i.e. to survey and collect data on how often an application such as e.g. a game application is actually executed (even without charging). The user may pay for the message in following applications eventually using also a value-added service for transferring the message. It is also possible that the message is sent to a toll-free number and that a respective information collecting company is charged for the message transfer. This may be applicable e.g. in case of promotion releases of applications, providing an instant feedback on the acceptance of a new software version. The user may pay for the message in following applications eventually using also a value-added service for transferring the message.

In another embodiment of the present invention the method of the invention is used for game applications on mobile terminals. In the following the expression ‘application’ is used to also encompass game applications.

In an example embodiment of the present invention said restricting limit comprises a time limit. This time limit may in case of a game application be a playing time limit or an application execution time limit, enabling a user to play e.g. for one minute up to several hours. It is also possible to use a fixed point in time (in the future) as an absolute time limit. Thus, a user may be allowed to play for the next 24 hours. It is also possible to combine both time limits enabling the use of the application for 3 hours within in e.g. the next week.

In an example embodiment of the method, said limit is an application inherent limit or event. Game application inherent limits may enable a user to play the application to a fixed point in the game e.g. up to the next level/stage or up to other game interrupting events such as a “game-over” or a “save” event. An application inherent limit may enable a user to use the application up to a fixed point in the application such as up to the next storage procedure or up to other application interrupting events such as termination of the playing of an audio or video file/data stream.

In game applications it may also be possible to activate certain essential game features such as the next amount of ammunition units in case of a weapon-based game such as e.g. Tomb Raider™. This principle may also be applied to the possibility to find game application elements or activating vehicles. It is also possible to use a kind of “airlock” with internal payment or messaging facility instead of a simple “door” to the next level. It may also be possible to use the messaging to enable just one single feature: storing the actual game stand. This feature would enable a skilled player to get a kind of reward for good playing, as when the game is played with less storage operations causing less cost for transmitting said message(s).

In another example embodiment of the present invention said sending of a message to a surveillance center further comprises setting up a connection to a surveillance center, and sending a message to a surveillance center, wherein said message comprises application execution related data. The method further comprises receiving from said surveillance center an authorization to an execution of said application within limits determined by said surveillance center.

This implementation can provide a supreme security against circumventing the messaging, by e.g. simulated message transfer. As the connection to network is essential for the invention, it is important to find a safe way to guarantee that the messages/indications are actually sent. Standard ok/fail indications may not necessarily provide enough security because those indications are necessarily not coming from the network, but may be a result of e.g. malicious software.

To make hacking more difficult, application developers may introduce a kind of security handshake with a network component owned by the network operator or perhaps by the application providing company itself This security handshake could for example be a small piece of (or a component of the) application, that is downloaded from a specific address every time an application or a game application is launched, including some kind of passkey verified by the application or game on the device. This passkey may also be generated in relation to information received from said terminal device, such as the actual application status. Using the same channel for transmitting the indications to the network operator could be done more safely after the handshake. If the application can not be started without a handshake, this would make the message transmission necessary. The handshake may also be performed when the application is started or when the game is being played—to make sure that online connection is still really existing or at least available.

According to the invention e.g. a game application may be distributed freely to the customer. If and when the user starts the game, the usage of the game is notified/informed online to a service center/game provider and the user can be forced to pay for playing the game.

In yet another example embodiment of the present invention said application execution related data comprises data selected from the group comprising application identification, mobile electronic terminal identification, user/player identification, communication parameter, and pin-code (Personal Identification Number).

By transferring an application identification, e.g. the name of the application and version and the serial (or individual) number of e.g. a game application would help application developing companies to receive important data about which of their applications/games are actually used, when and with what version number. The information can be used for application number specific coding, or a kind of actual gaming poll.

Other data to be transferred may comprise mobile electronic terminal identification (serial number), user identification (alias of login name with or without PIN number), a communication parameter (e.g. a telephone number, a SIM card identification), and a pin-code. User identification may also help to separate the payment from the actually used mobile terminal device. By using user identification the present invention can help building a user database that can be used to quantify an application market.

In yet another example embodiment of the present invention said application includes or induces the sending/transmissions of messages to said surveillance center. By an automated transmission of the message the system would be more convenient to use. This may be implemented by an application software code to execute the signaling procedure to the network based surveillance center.

In yet another example embodiment of the present invention said method further comprises outputting of a user-authorization request to transmit a message to a surveillance center, and detecting a user-authorization input authorizing said connection set up.

By using a user-authorization request to transmit a message to a surveillance center prior to setting up said connection to said surveillance center it is possible to prevent the occurrence of unwanted/unauthorized connection charges.

In another example embodiment of the present invention said method further comprises outputting a user-authorization request to perform a payment transaction, detecting a user-authorization input for authorizing said payment transaction, and performing said authorized payment transaction.

In yet another example embodiment of the present invention said authorized payment transaction is executed by a charging operation of an onboard charging device. A protected payment area or memory on the device or a game module or an application module that may be charged by a prepaid code may implement this. In this case the device can autonomously charge for the execution of an application even without any network connection. This implementation represents a kind of onboard payment device to debit for said limited execution of said game application. The protected payment area or memory implemented on the device provides a simple implementation for the user with only a single account. The single device account requires a dedicated messaging for directing a (virtual) cash flow to the application providing companies. A protected payment area or memory on an application module or game module solves the problem of distributing the payment flow but burdens the user with an number of confusing onboard payment accounts and payment procedures.

In yet another example embodiment of the present invention said authorized payment transaction is executed by transmitting said authorization for said payment transaction to said surveillance center.

By outputting a user-authorization request to perform a payment transaction the user is informed that the further use of the application is connected with charges. This request may be coupled with a possibility to select or determine a certain amount of means of payment a user may select an automated payment transaction, a limited payment transaction, or e.g. a notification of each means of payment transfer. These means of payment can also comprise token-type or code-type units in e.g. advertisement actions, such as it is known from number codes in bottles for getting MP3 coded music files. It is to be noted that the means of payment is not limited to official means of payment. This implementation may also be regarded as a kind of personally owned portable mobile online “video gaming machine” “or “amusement machine”.

By using user confirmed/authorized charging, the user can estimate how expensive the gaming can be. As an example the latest charging data would be fetched from the network and user would have to confirm it by entering e.g. a personal pin-code. This would disable unauthorized use of an application such as playing on someone else's bill. However the setting can be disabled to allow e.g. game addicts to play without code queries (like e.g. disabling pin-queries). It is also possible to implement an automated pin entry. By using e.g. value added services in a communication network, the authorization for setting up the connection/sending a message and performing a payment transaction may be performed in a one step procedure.

In another example embodiment of the present invention said payment transaction is charged to the next telephone bill. Thereby, a minimum implementation of this embodiment may comprise that the launch of an application such as a game is signaled to the network with user confirmation and will be charged in the next telephone bill.

For this implementation it is required that the network operator and the application company agree about the charging scheme and about the charging details. The charging would be based on the amount of indications and the owner of the SIM, and can possibly also be related for example to the time/place of the execution of the application and version number of the application. The network operator can charge the user via normal telephone bill and can pay the application company according to their agreement If there is a need to change the pricing concerning the execution of the application, the information could be sent to the user as described in the preceding text, e.g. together with an authorization message. The charging structures may use the same principles as e.g. conventional value-added services. In analogy to a price trend for conventionally released software, the pricing scheme for a certain application or a certain game may also be changed in relation to a changed use.

In yet another example embodiment of the present invention said messages are sent periodically. This approach for charging is relatively safe because price for sending a single message or indication is relatively low. Therefore, a certain error tolerance is built-in in the system, if e.g. the device is capable of ignoring that a single or a number of a few messages could not have been sent. For example, if the indications were only sent at the beginning and ending of the execution of the application it would become much more critical that indications are sent correctly indicating the correct time of activation and deactivation. This is especially true if the period between activation and deactivation is used as a basis for charging.

In another example embodiment of the present invention said application determines the number of messages to be sent and the point in time said messages are sent. That is, the frequency of sending indications can be selected by the running application. This solution enables application developers to define what kind of charging model they want to use. When the application or a game is not run on foreground or not running at all, no indications would be sent. As an example, a message or indication per 2 minutes could be used. It is also possible to use gaming events for example in a sports game application every time a new round of boxing match would induce a message or every first, second or 10^{th} round in a race game application may start the transmission of a message/indication.

In yet another example embodiment of the present invention said method further comprises determining that a message has not been sent.

In another example embodiment of the present invention a message is determined as not being sent, when a confirmation message that said message has been sent is not received within a defined period. That is the determination can also comprise the initiation of a timer circuit or with the transmission of the message.

In yet another example embodiment of the present invention said messages not sent are buffered in a buffer memory. This means that at least one message that has not been sent can be buffered and a normal or restricted execution of the application can be continued. That is, the transmission of the messages is only delayed e.g. for the reasons of lack of coverage of the mobile communication network, a high speed of motion resulting in fading, or other reasons. For example a traveler using an application on a high-speed train can be enabled to dispatch all messages at the next stop without any restrictions of the transmission. That is, an allowed delay of the transmission may comprise a period up to an hour or even longer up to 24 hours for inland travelers, one weekend or even several weeks for abroad trips.

In yet another example embodiment of the present invention said method further comprises determining the conditions preventing the sending/the transmission of said message, and starting/continuing a restricted execution of said application, within predetermined limits, if said message has not been sent and conditions that prevent the sending of said message are present.

This implementation means that e.g. in case of a game application playing the game may be possible, even if it is actually not possible to transmit said notifications. Thereby, a user may play the game or use the application in an area where no base stations of the communication network are available. This may be used e.g. by using an onboard GPS (Global Positioning System) or Galileo system to determine that the transmission of the messages is actually not possible, because the device is out of range. Short breakdowns of the network connection may occur but will not interrupt the execution of the application due to short blackouts in e.g. subway may be allowed, even if an online connection is otherwise required.

In another example embodiment of the present invention said method further comprises determining that a message has not been sent, starting/continuing a further restricted execution of said application, within further restricted predetermined limits, if said message has not been sent.

That is, the application can decide what to do, if the transmission of the message or the indication does not succeed. This may be termination of the application, limiting the usage of the application (e.g. only allowed to play the certain stage/level in case of a game application), buffering the indications in a way that when network can be contacted there will be several indications simultaneously. This means that eventually Network connection would be required, but short blackouts in e.g. subway would still be allowed, as the transmission of the messages is only deferred to a later point in time.

In another example embodiment of the present invention said method further comprises determining that a message has not been sent, and interrupting the execution of said application, if said message has not been sent.

By interrupting the execution of e.g. a game application in case of a failed message transmission it is possible to prevent uncharged gaming. A hard interruption of the execution of the application may lead to high frustration and aggression of the user. It is also possible to output advanced warnings, and to auto-store e.g. the game stand prior to interruption to abate the frustration due to a third-party game interruption.

In yet another example embodiment of the present invention said messages are sent via general packet radio service (GPRS). Thereby, the mobile device can be used to start the transmission of the indications. Thereby, the application developer or game developer can independently decide about the functionality of the features of the invention. The methods of sending data can use normal data channels. However, because of more or less continuous stream or periodical transmissions of indications GPRS may be preferred from the current available technologies. The data sent can be encrypted to make the transmissions more secure.

In another example embodiment of the present invention said method further comprises downloading application software to said mobile terminal device. By downloading the application software a distribution path can be provided which does not require any retail trade. The download may be offered free of charge, or free of extra charge to the data connection costs.

In another example embodiment of the present invention said method further comprises determining the actual date, checking said actual date with a time rule provided in said application, and interrupting the execution of said application, if said actual date does not meet the requirements of said time rule.

The actual date can be determined by said application and may b e received from said surveillance center via a message or from said communication network. It is also possible that the applications themselves could be working only a specified time, e.g. a month, after which an update would have to be retrieved from the network. If there is any hacking activity on a specific application, the security could be improved or merely changed between different versions of the application.

According to another aspect of the present invention a method is provided for generating at a surveillance center messages for mobile terminal devices for enabling the surveyed execution of applications on said mobile terminal device. The method comprises receiving a message from a mobile terminal device at a surveillance center, wherein said message comprises application execution related data, and generating an authorization to a restricted execution of said application within predetermined limits on said mobile terminal device, and sending said authorization to said mobile terminal device.

This part of the invention is related to the server side or the surveillance center side of the present invention. The disclosed method provides a possibility to evaluate different information as received or stored in said surveillance center. It is possible to implement these messages as a kind of competition, wherein a closer relationship between the application developers and the user of the application may be established.

In an example embodiment of the present invention said method further comprises evaluating said message received from said mobile terminal device at a surveillance center, storing a result of said evaluation and an identification related to the use of said application in said evaluation circuit, and generating said authorization to a restricted execution of said application in accordance with said result of said evaluation.

It is also possible to use the surveillance center as a center for performing charging transactions. The charging may also be performed in a kind of “prepaid” solution as a means for charging. In this case a customer would have to buy code sequences to load an amount of currency to a virtual account, wherein at each reception of a message a predefined amount is transferred to the account of the provider of the application.

To make hacking more difficult, game or application developers may introduce a kind of security handshake with a network component owned by network operator or perhaps the game or application providing company itself. This security handshake can for example be a small piece of (or a component of the) application which is downloaded from a specific address every time application is launched, and may include a kind of passkey verified by the application on the device.

According to yet another aspect of the invention, a software tool is provided comprising program code means for carrying out the method of the preceding description when said program product is run on a computer or a network device.

According to another aspect of the present invention, a computer program product stored on a computer readable medium or being downloadable from a server fox carrying out the method of the preceding description is provided, which comprises program code means for performing all of the steps of the preceding methods when said program is run on a computer or a network device.

According to yet another aspect of the present invention a mobile terminal device for surveyed executing application on a mobile terminal is provided. Said mobile terminal device for executing surveyed application comprises a processing unit, a user interface, an authorization circuit, and a radio interface to a communication network. Said processing unit is capable of executing applications. Said user interface is connected to said processing unit, and is provided for receiving user input. Said authorization circuit is connected to said processing unit for detecting and restricting the execution or the starting of an application, and notifying the use of said application to a surveillance center. Said radio interface to a communication network provides a possibility for notifying the execution of application to a surveillance center connected to said communication network. That is, the present invention provides a method to notify and survey the actual use of an application nearly in real-time.

Said authorization circuit is configured to notify the execution or the starting of an application to a surveillance center via the radio interface, and is further configured to restrict the execution of said application in accordance with the notify status to said surveillance center.

The present invention provides a mobile terminal device to enable surveyed execution of an application. It is to be noted that the application may be provided on a hardware module as known from portable gaming devices. Especially in case of hardware module based applications the authorization circuit can be implemented a hardware component, as the electric and logic interface of the hardware module to the mobile device is well defined. The messages may be directed to value-added services to enable charging for executing the application such as playing a game application on said terminal device.

In an example embodiment of the present invention said radio interface is further configured to receive authorization messages from said surveillance center. The authorization messages comprise limits for executing a certain application, and wherein said authorization circuit is configured to restrict the start/execution of application on said processing unit in accordance with said limits.

In an example embodiment said mobile terminal device is a game terminal device. In this embodiment a portable game device can use a messaging for enabling a kind of game software pay per use concept.

In another example embodiment said mobile terminal device comprises a cellular telephone that is capable of executing applications.

In yet another example embodiment said mobile terminal device further comprises a buffer for messages, wherein said buffer being connected to said authorization circuit.

According to yet another aspect of the present invention a surveillance center for generating authorization messages for a mobile terminal device is provided. The surveillance center enables the execution of an application on a mobile terminal device. Said surveillance center comprises an interface to a mobile communication network and an authorization generation circuit. Said interface to a mobile communication network is for receiving messages comprising application execution related data from mobile terminal devices. Said authorization generation circuit is connected to said interface for generating an authorization for a restricted execution of said application within predetermined limits on said mobile terminals. Said interface is configured to send said authorization as a message via said communication network to said mobile terminal device.

As already indicated in the preceding text the use of a handshaking procedure can increase the security that a message is actually dispatched to a surveillance center, which is essential for the payment-per-use implementations of the present invention. Since the connection to a communication network is essential for the invention, it is important to guarantee that the indications are actually sent.

The surveillance center can perform a kind of security handshake with a network component owned by network operator or perhaps the application providing company itself. When using the same channel for transmitting the indications and the authorization message the user may be charged for the whole data traffic of the handshake procedure. The generation of the message may comprise the evaluation of different parameters received or stored in said surveillance center.

In an example embodiment of the present invention said surveillance center further comprises an evaluation circuit and a database. Said evaluation circuit is connected to said authorization generation circuit and is provided to evaluate messages received via said interface from a mobile terminal device. Said database is connected to said evaluation circuit, for storing a result of said evaluation and an identification related to the user or the user device of said application in said evaluation center. Said authorization generation circuit is configured to generate said authorization to a restricted execution of said application in accordance with said result of said evaluation circuit. This may also comprise the evaluation of different parameters received and/or stored in said surveillance center.

According to yet another aspect of the present invention a surveyed application execution system is provided that comprises at least a mobile terminal device comprising a processing unit, a user interface, an authorization circuit, and a radio interface to a communication network, and a surveillance center comprising an interface to a mobile communication network and a generation circuit.

In the following, the invention will be described in detail by referring to the enclosed drawings in which:

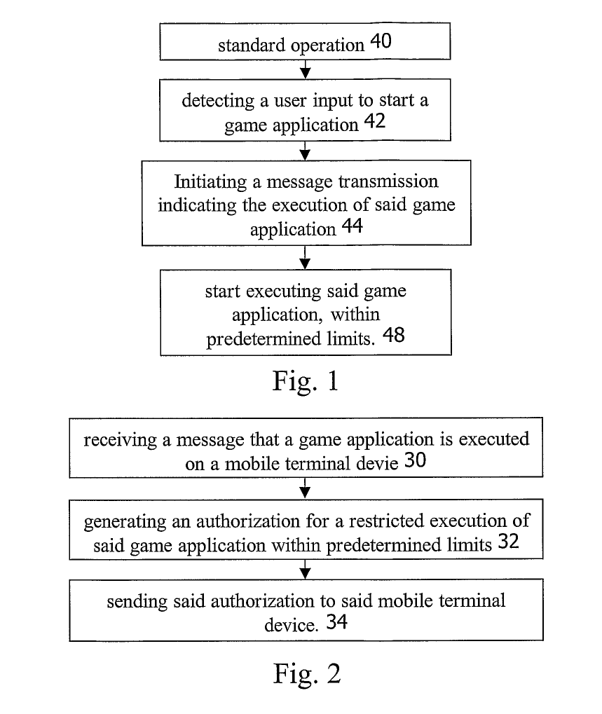

FIG. 1 is a flowchart depicting the method of the present invention to be executed on a mobile terminal device,

FIG. 2 is a flowchart depicting the method of the present invention, to be executed on a surveillance center,

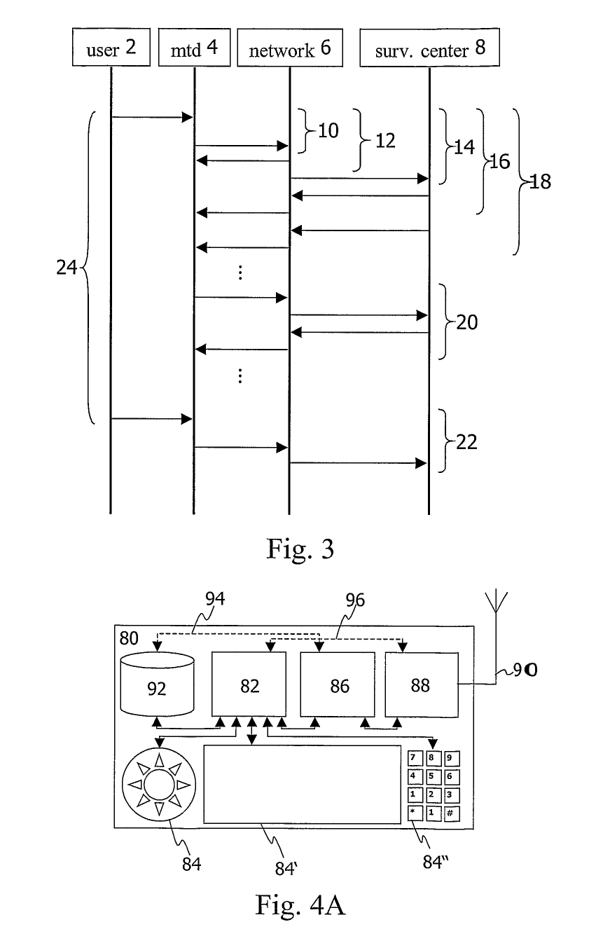

FIG. 3 is a flow diagram visualizing different data exchange procedures,

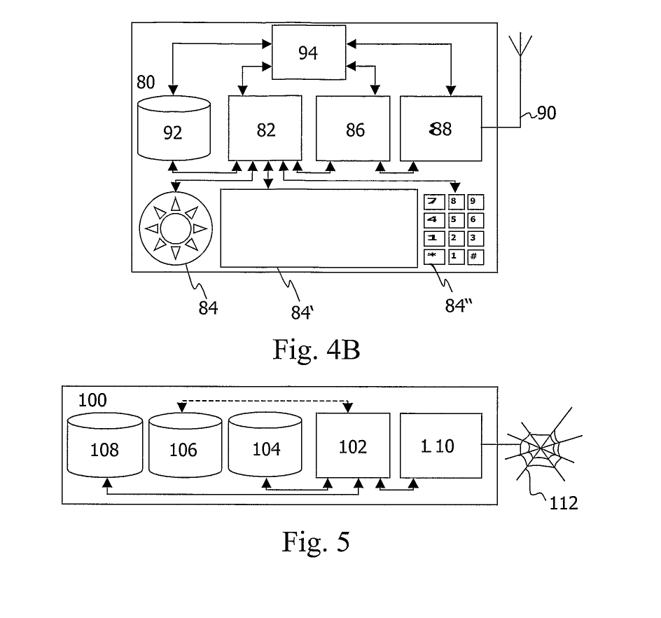

FIGS. 4A and 4B are schematic block diagrams of mobile terminal devices according to the present invention,

FIG. 5 is a schematic block diagram of a surveillance center device according to the present invention, and

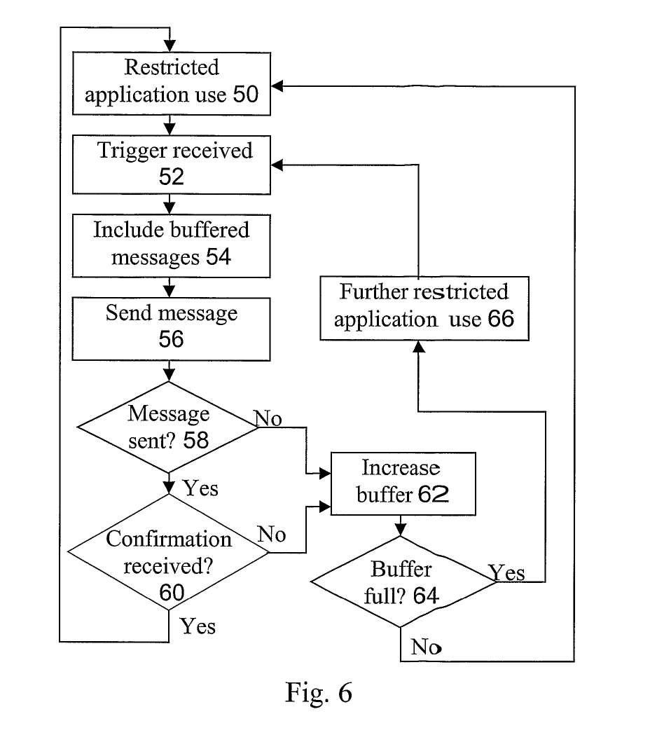

FIG. 6 is a schematic block diagram of a combination of confirmation messages and the use of a message buffer for messages directed to said surveillance center according to the present invention.

In the figures there are provided non-limiting examples for the surveyed executing of a game application on a mobile terminal device, as an example for an application.

FIG. 1 is a flowchart depicting the method to be executed on a mobile terminal device of the present invention. The method for the surveyed executing of a game application on a mobile terminal device takes a standard operational state 40 as starting point. This standard operation state can be an idle state, a standby mode, or an operational mode or a turned off state. Then the device detects 42 a user input that is directed to start the execution of a game application on said mobile terminal device. This input to start the execution can be an input to start a game application, to continue/resume a game application, or even a powering up game start input.

Following to the detection of said input to execute said game application the device generates and sends 44 a message to a surveillance center, wherein said message indicates the execution of a game application. It is also possible that the message just indicates that a game application has been started.

In a next optional step the device may determine if the message has actually been sent. This may be implemented by an acknowledge message from the network or from the surveillance center.

Then the device starts 48 a restricted execution of said game application, within predetermined limits, after said message has been sent.

The depicted messaging without said optional confirmation of said sending of said message can be performed without receiving any reply messages. Then the limits have to be implemented in the game application or in the terminal device, as such the terminal device does not necessarily receive any messages.

This implementation can also be extended to a complete data exchange with game application execution confirmation or authorization.

In the basic implementation of FIG. 1 it is left open what happens when the message has not been sent.

FIG. 2 is a flowchart depicting the method of the present invention, to be executed on a surveillance center. The method can be executed in connection with a confirmation or authorization based messaging procedure on a mobile terminal device.

The method starts with receiving 30 at a surveillance center a message from a mobile terminal device via mobile communication network. The message comprises game application execution related data. The message comprises at least that a game is actually executed on a mobile terminal device. The message can also comprise additional information such as a game identification, terminal device identification, as player identification, and other data, such as the actual game level played. The device generates in a next step 32 an authorization for a restricted execution of said game application within predetermined limits on said mobile terminal device.

Then the generated authorization 34 is sent to said mobile terminal device. The method can be extended by implementing charging procedures for sending authorization messages.

FIG. 3 is a flow diagram visualizing different data exchange procedures. FIG. 3 depicts the up to four entities that can interact to use the present invention. The depicted system comprises the components user 2, mobile terminal device (MTD) 4, network 6 (wireless mobile communication network), and a surveillance center 8.

The bracket 24 indicates the execution of a game application and indicates a user input to start a game application and to terminate the execution of a game application, as indicated by the arrows from the user 2 to the MTD 4. Other user input to control the game or to interact with the game has been omitted not to obscure the diagram.

The bracket 10 indicates a minimum implementation of the present invention wherein upon the detection of user input to start a game application a message is dispatched. In this basic implementation there is no requirement for any kind of confirmation. This implementation can be applied if the execution data of a game application are used only for statistics.

The bracket 12 indicates a more sophisticated implementation of the present invention wherein a confirmation message is sent back from the network 6 to the MDT 4, indicating that the message has been sent/transferred. This implementation may be applied when the surveillance center 8 is an integral part of the network 6.

The bracket 14 indicates the use of surveillance center 8, wherein said messages are sent via said network 6 to said surveillance center 8. This implementation may be applied when the manufacturer of the game application operates the surveillance center 8. This implementation may be applied if the execution data of a game application are used only for statistics of e.g. the manufacturer of the game application. In this case a dedicated confirmation message sent back to the mobile terminal device 4 is not necessary.

The bracket 16 indicates a more sophisticated implementation of the present invention wherein a confirmation message is sent back from the surveillance center 8 to the MDT 4, indicating that the message has been sent/transferred. This implementation is analog to the method indicated by the bracket 12.

The bracket 18 extends the method of bracket 16 by an authorization message that is sent from the surveillance center 8 to the mobile terminal device 4, to enable the execution of a game application under limits determined by said surveillance center 8. In this implementation the surveillance center may also be regarded as a kind of authorization center to authorize the restricted execution of a game application on said terminal device.

The bracket 20 represents additional data exchanges between the mobile terminal device 4 and the surveillance center 8. These additional data exchange may become necessary if and when the restriction or a limit of the game execution becomes noticeable. That is, the bracket 20 represents additional game execution related data exchanges. If e.g. a limitation of the execution of a game application e.g. a game period of 5 minutes that has been granted has passed a new data exchange with the surveillance center may be necessary to continue a game.

The bracket 22 represents an additional data exchange between the mobile terminal device 4 and the surveillance center 8 to notify the termination of the execution of said game application. The data traffic is basically the same as the one of bracket 14, with the difference that the confirmation message may be futile, as the game application may already be terminated, when a confirmation with a time delay is received.

FIG. 4A is a schematic block diagram of a mobile terminal device 80 according to the present invention. The mobile terminal device 80 comprises a processing unit 82, a user interface 84-84″, a memory device 92, an authorization circuit 86, and a radio interface 88 with an antenna 90.

The processing unit 82 is capable of executing game applications, and is connected to a user interface 84-84″ connected to enable an interaction between an user and a game application running on said device 80. The user interface 84-84″ comprises a joystick type control element 84, a display 84′ and a Keypad 84″. With the storage 92 the device represents a conventional portable video game device. The device according to the invention further comprises an authorization circuit 86, and a radio interface 88 with an antenna 90.

The authorization circuit 86 is connected to said processing unit 82 for detecting if a game application is executed on said processing unit, and for restricting the execution of game application on said processing unit 82.

The authorization circuit 86 is further connected to a radio interface to a communication network for notifying the execution of game application to a surveillance center connected to said communication network, if and when a game application is executed on said processing unit 82. The authorization circuit 86 is further configured to receive messages from said surveillance center via said radio interface 88 to receive authorizations to allow said processing unit 82 to execute said game application.

There may also be a connection 96 between said processing unit 82 and said radio interfaces 88 provided to enable interactive gaming or to enable data/games download. It is also possible to provide a connection 94 between said storage unit 92 and said authorization circuit 86. This connection can be used if e.g. memory modules are used to enable a direct access to the authorization circuit 86 to dispatch a message when e.g. the processing unit accesses game application data stored on said storage module 92.

FIG. 4B represents a schematic block diagram the mobile terminal device 80 of FIG. 4A that is provided with a dedicated hardware surveillance component 94 that is configured to control the application execution and the transmission of the messages.

The hardware surveillance component 94 is connected at least with said processing unit 82. The hardware surveillance component 94 can also be connected to said memory device 92, said authorization circuit 86, and a radio interface 88 with an antenna 90.

The hardware surveillance component 94 can be an integral part of the mobile terminal device 80, or can be a part of an application module having an memory storing said application and/or having hardware components for execution said application. The hardware surveillance component 94 can comprise separate hardware implementations for executing each step of the method of the present invention. It is for example possible to implement a counter counting up each not transmitted message and counting down with each received confirmation of a message. A threshold of the counter may be selectable by a respective value provided by the application or by an application module.

It is also possible to implement e.g. a timer circuit in the hardware surveillance component 94 to be able to decide if a message has been sent successfully or not. The timer circuit in the hardware surveillance component 94 can also be used to determine a maximum period to execute an application without any network access. Application software or a hardware module of an application module can also control these hardware timer components.

The hardware surveillance component 94 can influence the execution of a software application by using a direct connection to the processing unit 82, to influence the application execution directly on the processing unit 82 e.g. by limiting the available operative memory.

The hardware surveillance component 94 can be connected to an audio output to interrupt or fade the sound effects during the game execution if the conditions for a further restricted use are present. The user has a chance to at least store e.g. the actual game stand.

It is possible to implement the hardware surveillance component 94 as a special protected area on the device or on an application/memory module. The hardware surveillance component 94 can be implemented in a secure multimedia (MMC) card, which can provide such special protected areas.

FIG. 5 is a schematic block diagram of an implementation of a surveillance center device 100 according to the present invention. The surveillance center 100 is for generating messages for mobile terminal devices for enabling the surveyed execution of a game application on a mobile terminal device (as e.g. depicted in FIG. 4).

The surveillance center 100 comprises an interface 110 to a mobile communication network 112 for receiving messages comprising game application execution related data from a mobile terminal device. The surveillance center 100 further comprises an authorization generation circuit 102 connected to said interface 110.

The authorization generation circuit 102 can receive messages from mobile terminal devices via said communication network requesting authorizations to execute a game application. The authorization generation circuit 102 can generate an authorization for a restricted execution of game applications on mobile terminals within arbitrary or predefined limits.

The authorization generation circuit 102 is connected to different databases 104, 106, 108 providing the data necessary to generate said authorization. The database 104 can e.g. be a game application database to store all the game relevant data, codes limitations and the like. The database 108 can e.g. be a player or a user device database to store all user relevant data to be able to obtain relevant statistical data. The optional database 106 can be a charging database to store charging data, perform caching operations for playtimes or game levels granted to a user or a terminal device.

The interface 110 is further configured to send said generated authorization as a message via said communication network 112 to said mobile terminal device to enable a restricted execution of a game application.

FIG. 6 is a schematic block diagram of a combination of confirmation messages and the use of a message-sending buffer for messages directed to said surveillance center according to the present invention. The start of the application according to FIG. 1 is not shown in FIG. 6. In FIG. 6 the application is executed in the normal restricted application use 50 mode wherein the use of the application is allowed when messages are sent to the surveillance center.

In the next step a trigger event is received 52 to start an attempt to dispatch a message to the surveillance center. The trigger signal may be generated by the application or by a dedicated surveillance hardware module (see FIG. 4B).

The triggered attempt to send a message to the surveillance center comprises a check if there are buffered messages present, and the inclusion of the buffered messages to the message to be sent. By including said buffered messages 54 a repeated transmission of messages wasting network resources can be prevented.

Next an attempt to send the message 56 via the network is started.

The block 58 determines if the message has been sent and the subsequent block 60 determines if a confirmation of the sent message has been received. If the message has been sent and the message has bee confirmed, the normal restricted application use 50 mode up to the next trigger event.

If and when the message has not been sent or no confirmation for the message is received the message is stored in the message buffer increasing the buffer content 62. Then it is determined if the buffer is full 64 i.e. reaches a determined limit or threshold. The normal restricted application use 50 is resumed if the buffer determined to be not full.

Then if is determined that the buffer is full 64 has reached a determined limit or threshold a further restricted execution of the application 66 is used as additional limit. The further restricted execution can comprise limitation such as restricted audio output, switched off user interface elements or functionality elements of the application. If at the next trigger event a message can be sent the normal restricted application execution mode is resumed.

A deletion of the messages in the buffer may be performed after receiving a confirmation of a successfully sent message. That is a buffer clearing step may be inserted in the direct connection between blocks 60 and 50. Thereby a buffer overflow due to expired messages can be prevented.

That is, the number of initiated but actually not sent messages (or the messages itself) is stored. The application (or a respective hardware module) checks at each start of the application or at any other trigger event if the number of the not sent messages has reached or exceeded a predefined number. If this number has been exceeded the start or the execution of the application is interrupted or the functionality of the application is subject to more severe restrictions. If and when the message can be sent again e.g. due to a return into an area with a cell coverage and a respective confirmation is received the normal restricted execution of the application is again resumed. The actual implementation may require a more complex system to distinguish between confirmations and message sending if the confirmation is not sent for all the messages. It is further to be noted that the method of the invention as depicted e.g. in FIG. 6 can be implemented both in software and hardware for message sending and buffering. For security reasons a hardware implementation may be preferred.

Instead of the conventional approach of owning game applications, the present invention proposes the use of freely copyable, but chargeable game applications.

This would enable users to get any game applications they want without any risks of making wrong investment. The usage of games would be charged (with user confirmation) instead of actually owning it. This can be achieved by using mobile network to transfer the information of game usage, namely the game would signal the information of usage to the network. This charge should be very small compared to the price for buying the game, but the amount of time used with the game will make it up.

Setting up distribution channels for the game application architecture would be easy to implement. Basically, the game can be freely available in public media, such as Internet, and can be freely copyable. Only a server providing the game files is required. An update of the game application files would not require calling back massive amounts of storage media such as MMCs or anything like that. The system would also enable really rapid and wide distribution of the games, and moreover rapid and wide surveillance of the use of the game.

There are no requirements or risks concerning copy protection because the whole concept is changed. The focus would be more on making sure that the game usage information is transferred correctly to the network. But having the calling mechanism implemented in the game is quite safe way of its implementation, preferably requiring some interaction with the network to make sure information is handled correctly. This data can even be encrypted to be more failsafe and fraud-safe. also if there is a tweak in the system, it is up to the game developers or the ones responsible for the network implementation to provide a fix.

The present invention may help to make conventional distribution channels virtually obsolete, therefore saving much time and money.

One aspect of the invention, the handling out-of-coverage situations, is to be solved by the software developers. although, it would already mean that multi-player games using mobile networks can not be played at all, reducing the problem to single player games. If the system is implemented to the games, it is up to game publishers to decide whether or not the game can be played at all when there is no network available. It is also possible that the user is enabled to play only a predetermined period under out-of-network-coverage conditions. While in these circumstances the game would perhaps save the information/messages and send them to the network if and when it is available again.

It is also possible that the game companies can charge the player directly. However, such charging channels and infrastructure is actually not a common standard for those companies. But in the future such individual charging channels can be implemented easily using standard charging application such as the pre-paid concept of mobile phones operators. It is easier if the operators of the communication network do the billing, also in view of implementations of gaming applications in future communication network architectures. Most importantly there should be both game/terminal applications and network support for the features of the present invention.

The minimal requirement for the present invention is that game launch or execution is signaled to the network. The signaled information could comprise e.g. game “x” started at this time (and ended at that time). This signaling in combination with user confirmation can be used for charging the user of the software e.g. in the next telephone bill.

The operator would then have agreements with different game publishers to have the credit going to the correct account. also terminal manufacturer certified game applications may use the present invention. The operator of the communication network would then have agreements with different game publishers to have the credit going to the correct account. A network confirmation for the transaction could be important to provide the system with an improved safety. One aspect of the present invention resides in that a downloadable game employs a separate charging procedure for using it.

The distribution of the game application can use media such as MMCs, CD-ROMs or online connections such as public landline networks, TV-cable networks and mobile communication, and especially any kind of Internet connection for loading the game applications to mobile devices.

Even if the preferred embodiment is based on the execution of game applications the invention can be used for any other type of applications on mobile devices. This also includes the processing of multimedia content like music and video files.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for the surveyed executing of an application on a mobile terminal device, comprising:
detecting a user input directed to start the execution of an application on said mobile terminal device,
initiating a message to a surveillance center, wherein said message indicates the execution of an application, and
starting a restricted execution of said application, within predetermined limits, after said message has been initiated.

2. Method according to claim 1 further comprising
sending said message to said surveillance center, and
starting said restricted execution of said application, within predetermined limits, after said message has been sent.

3. Method according to claim 1, wherein said application is a game application.

4. Method according to claim 1, wherein said message indicates the start of an execution of an application.

5. Method according to claim 1, wherein said limit comprises a time limit.

6. Method according to claim 1, wherein said limit comprises a limit of said application.

7. Method according to claim 1, wherein said initiating of a message to said surveillance center comprises
setting up a connection to a surveillance center,
sending a message to a surveillance center, said message comprising application execution related data, and
receiving an authorization to execute said application within said limits defined by said surveillance center.

8. Method according to claim 7, wherein said application execution related data comprise
data selected from the group comprising: application identification, mobile electronic terminal identification, user identification, player identification, communication parameter, and pin-code.

9. Method according to claim 1, wherein said application starts the sending of a message to said surveillance center.

10. Method according to claim 7, further comprising:
outputting a user-authorization request to send a message to a surveillance center, and
detecting a user-authorization input authorizing said connection set up.

11. Method according to claim 1, further comprising:
outputting a user-authorization request to perform a payment transaction,
detecting a user-authorization input for authorizing said payment transaction, and
performing said authorized payment transaction.

12. Method according to claim 11, wherein said authorized payment transaction is performed by charging an onboard payment device.

13. Method according to claim 11, wherein said authorized payment transaction is performed by sending said authorization for said payment transaction to said surveillance center.

14. Method according to claim 11, wherein said payment transaction is charged to the next telephone bill.

15. Method according to claim 1, wherein said message is sent periodically.

16. Method according to claim 1, wherein said application determines the number of messages to be sent and the point in time a message is sent.

17. Method according to claim 1, further comprising:
determining that a message has not been sent.

18. Method according to claim 17, wherein said message is determined as not being sent, if a confirmation message that said message has been sent is not received within a defined period.

19. Method according to claim 17, further comprising:
buffering of said messages not sent.

20. Method according to claim 17, further comprising:
determining conditions that prevent the sending of said message, and
starting/continuing a restricted execution of said application, within defined limits, if said message has not been sent and conditions that prevent the sending of said message are present.

21. Method according to claim 17, further comprising:
starting/continuing a further restricted execution of said application, within further restricted defined limits, if said message has not been sent.

22. Method according to claim 1, further comprising:
receiving a confirmation message that said message has been sent.

23. Method according to claim 1, further comprising:
determining that a message has not been sent, and
interrupting the execution of said application, if said message has not been sent.

24. Method according to claim 1, wherein said message is sent via general packet radio service.

25. Method according to claim 1, further comprising downloading application software to said mobile terminal device.

26. Method according to claim 1, further comprising:
determining the actual date,
comparing said actual date with time rule provided in said application, and
interrupting the execution of said application, if said actual date does not meet said time rule.

27. Method for generating messages destined for mobile terminal devices for enabling the surveyed execution of an application on said mobile terminal device, comprising:
receiving a message from a mobile terminal device at a surveillance center, said message comprising application execution related data,
generating an authorization to a restricted execution of said application within predetermined limits on said mobile terminal device, and
sending said authorization to said mobile terminal device.

28. Method according to claim 27, further comprising:
evaluating said message received from said mobile terminal device at a surveillance center,
storing a result of said evaluation and an identification related to the use of said application in said data base, and
generating said authorization to a restricted execution of said application in accordance with said result of said evaluation.

29. Method for enabling the surveyed execution of an application on said mobile terminal device, by using a data exchange with a surveillance center, comprising the steps of claim 1.

30. Software tool comprising program code means stored on a computer readable medium for carrying out the method of claim 1 when said software tool is run on a computer or network device.

31. Computer program product comprising program code means stored on a computer readable medium for carrying out the method of claim 1 when said program product is run on a computer or network device.

32. Mobile terminal device for the surveyed executing of an application, comprising:
a processing unit, capable of executing an application,
a user interface connected to said processing unit, for receiving user input
an authorization circuit connected to said processing unit for detecting, notifying and restricting the execution of said application, and
a radio interface to a communication network for notifying the execution of said application to a surveillance center connected to said communication network,
wherein said authorization circuit is configured to notify the execution of said application to a surveillance center, and is further configured to restrict the execution of said application in accordance with predetermined limits.

33. Mobile terminal device according to claim 32, wherein said radio interface is further configured to receive authorizations from said surveillance center, comprising said limits for executing said application, and wherein said authorization circuit is configured to restrict the execution of said application on said processing unit in accordance with said limits.

34. Mobile terminal device according to claim 32, wherein said mobile terminal device is a game terminal device.

35. Mobile terminal device according to claim 32, wherein said mobile terminal device comprises a cellular telephone.

36. Mobile terminal device according to claim 32 further comprising a buffer for messages, said buffer being connected to said authorization circuit.

37. Surveillance center for generating messages for mobile terminal devices for enabling the surveyed execution of an application on said mobile terminal device, comprising:
an interface to a mobile communication network for receiving messages comprising application execution related data from a mobile terminal device, and
an authorization generation circuit connected to said interface for generating an authorization for a restricted execution of said application within predetermined limits on said mobile terminal,
wherein said interface is configured to send said generated authorization as a message via said communication network to said mobile terminal device.

38. Surveillance center according to claim 37, further comprising:
an evaluation circuit, connected to said authorization generation circuit, to evaluate messages received from said mobile terminal device, via said interface, and
a database connected to said evaluation circuit, for storing a result of said evaluation and an identification related to the use of said application in said evaluation circuit,
wherein said authorization generation circuit is configured to generate said authorization to a restricted execution of said application in accordance with a result received from said evaluation circuit.

39. Application execution system comprising: a mobile terminal device comprising:
a processing unit capable of executing an application,
a user interface connected to said processing unit for receiving user input,
an authorization circuit connected to said processing unit for detecting, notifying and restricting the execution of said application, and
a radio interface to a communication network for notifying the execution of said application to a surveillance center connected to a communication network,
wherein said authorization circuit is configured to notify the execution of said application to a surveillance center, and is further configured to restrict the execution of said application in accordance with predetermined limits, and
a surveillance center comprising:
an interface to a mobile communication network for receiving messages comprising application execution related data from a mobile terminal device, and
an authorization generation circuit connected to said interface for generating an authorization for a restricted execution of said application within predetermined limits on said mobile terminal,
wherein said interface is configured to send said generated authorization as a message via said communication network to said mobile terminal device.

40. Method for enabling the surveyed execution of an application on said mobile terminal device, by using a data exchange with a surveillance center, comprising the steps of claim 27.

41. Software tool comprising program code means stored on a computer readable medium for carrying out the method of claim 27 when said software tool is run on a computer or network device.

42. Computer program product comprising program code means stored on a computer readable medium for carrying out the method of claim 27 when said program product is run on a computer or network device.
